(19) United States
(12) Patent Application Publication
(10) Pub. No.: US 2012/0062563 A1
(43) Pub. Date: Mar. 15, 2012

(54) PRE-PROVIDING AND PRE-RECEIVING MULTIMEDIA PRIMITIVES

(75) Inventors: Alexander St. John, San Francisco, CA (US); Kevin Gliner, San Francisco, CA (US)

(73) Assignee: hi5 Networks, Inc., San Francisco, CA (US)

(21) Appl. No.: 13/232,533

(22) Filed: Sep. 14, 2011

Related U.S. Application Data
(60) Provisional application No. 61/382,843, filed on Sep. 14, 2010.

(51) Int. Cl. G06T 15/00; G06T 1/00; G06F 15/16

(52) U.S. Cl. 345/419; 709/219; 345/522

(57) ABSTRACT

In various embodiments, apparatus, systems, computer-readable media and methods for pre-providing and pre-receiving multimedia primitives are provided. In various embodiments, a server portion of a client-server portion application may receive, from a client portion of the client-server application, data indicative of a current state or transition into the current state of the client portion of the client-server application. In various embodiments, the server portion may pre-provide, and the client portion may pre-receive, a plurality of multimedia primitives, different combinations of which are employed in different ones of a plurality of potential next states of the client portion of the client-server application, to enable the client portion of the client-server application to reduce transition time to one of the potential next states.

### CROSS REFERENCE TO RELATED APPLICATIONS

This application claims priority under 35 U.S.C. §119(e) to U.S. Provisional Patent Application No. 61/382,843 entitled “MULTI-MEDIA APPLICATION WITH PREDICTIVE REAL-TIME CONTENT DELIVERY,” filed Sep. 14, 2010, the disclosure of which is incorporated herein by reference.

### TECHNICAL FIELD

Embodiments of the present disclosure relate generally to the technical field of data processing, and more specifically to pre-providing and pre-receiving multimedia primitives in association with a client-server application.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

A client-server application may include a server computer program (hereafter referred to as a “server portion”) executing on a server computer system and one or more client computer programs (hereafter referred to as “client portions”) executing on one or more client computer systems. The server portion and the one or more client portions may exchange data over one or more networks such as the Internet.

In client-server applications that are online games, a user may interact with a client portion (e.g., using a mouse, keyboard and/or other input devices) to play the game. In some cases, a server portion of the online game may deliver graphics representing gameplay, such as real-time streamed video, to the client portion. There may be latency between the client portion and the server portion that may cause undesirable delays and breaks in gameplay, as well as make the client portion of the game appear less responsive. For example, a game interaction may be initiated at a client portion by a user and sent by the client portion, over one or more networks, to the server portion to be processed as part of gameplay. If the network includes portions that are congested, there may be noticeable delay before the client portion receives a response and outputs a next state of the client portion to the user.

### SUMMARY

In various embodiments, the present disclosure provides apparatus, systems, computer-readable media and methods for anticipating the need for, pre-providing and/or pre-receiving multimedia primitives in order to reduce network delivery latency of assets for use in a real-time application. In various embodiments, a server portion of a client-server portion application may receive, from a client portion of the client-server application, data indicative of a current state or transition into the current state of the client portion of the client-server application. In various embodiments, the server portion may pre-provide, and the client portion may pre-receive, a plurality of multimedia primitives, different combinations of which are employed in different ones of a plurality of potential next states of the client portion of the client-server application, to enable the client portion of the client-server application to reduce transition time to one of the potential next states.

### BRIEF DESCRIPTION OF THE DRAWINGS

In the following detailed description, reference is made to the accompanying drawings which form a part hereof wherein like numerals designate like parts throughout, and in which is shown by way of embodiments that illustrate principles of the present disclosure. It is to be understood that other embodiments may be utilized and structural or logical changes may be made without departing from the scope of the present disclosure. Therefore, the following detailed description is not to be taken in a limiting sense, and the scope of embodiments in accordance with the present disclosure is defined by the appended claims and their equivalents.

FIG. 1 schematically illustrates components that may be utilized in a client-server application, in accordance with various embodiments.

FIG. 2 depicts an example method that may be implemented by a server portion of a client-server application, in accordance with various embodiments.

FIG. 3 depicts an example method that may be implemented by a client portion of a client-server application, in accordance with various embodiments.

FIG. 4 schematically depicts an example system on which various disclosed methods may be implemented, in accordance with various embodiments.

### DETAILED DESCRIPTION

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific devices and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise.

In providing some clarifying context to language that may be used in connection with various embodiments, the phrases “A/B” and “A and/or B” mean (A), (B), or (A and B); and the phrase “A, B, and/or C” means (A), (B), (C), (A and B), (A and C), (B and C) or (A, B and C).

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

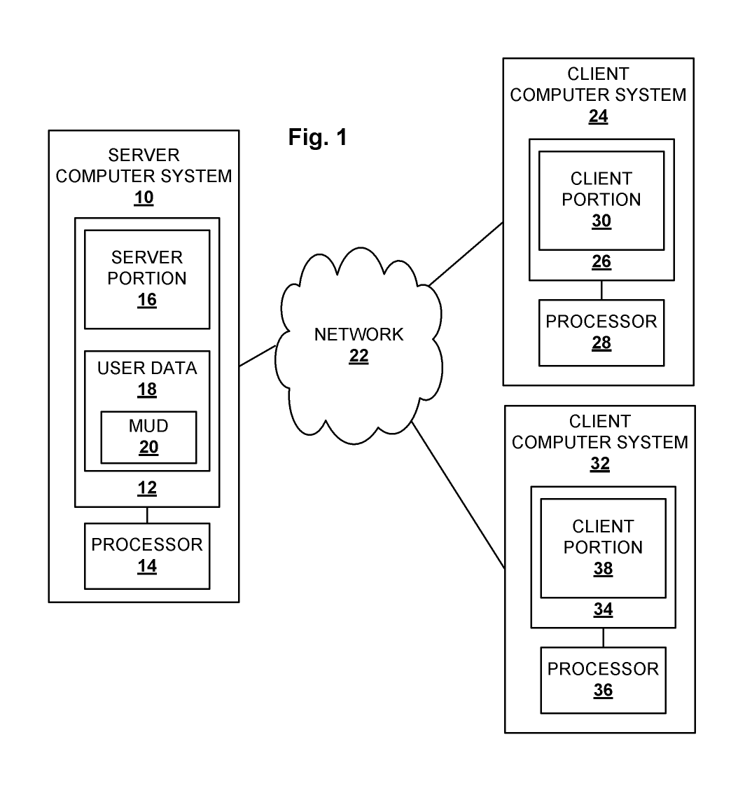

Referring to FIG. 1, a server computer system 10 may include memory 12 operably coupled to one or more processors 14. Memory 12 may come in various forms, such as random access memory, or “RAM,” one or more hard disk drives, solid-state memory, portable disks such as digital versatile disks, or “DVDs,” and so forth. Server computer system 10 may be a single unit that houses memory 12 and one or more processors 14, or these components may be distributed among multiple units, for instance, of a server farm. In accordance with various embodiments, one or more processors 14 may operate a server portion 16 of a client-server application. Server portion 16 may include instructions stored in memory 12 that are executable by one or more processors 14.

Memory 12 may also store user data 18. User data 18 may include data collected from client portions of the client-server application of which server portion 16 is part, such as measured user data 20 (referred to as “MUD” in FIG. 1) associated with actions taken by users while using client portions of the client-server application. In various embodiments, user data may include other individual and aggregate information about users of the client-server application, such as demographic and/or statistical information about users individually or collectively.

Server computer system 10 may be connected through a network 22 to a first client computer system 24. Network 22 may include one or more local or wide area networks, such as the Internet.

First client computer system 24 may be any type of computer system, such as a desktop computer, a laptop, a tablet, a set-top box, a game console, a smart phone, a portable media player, and so forth. Similar to server computer system 10, first client computer system 24 may include memory 26 and one or more processors 28. A first client portion 30 of the client-server application may be operated by one or more processors 28 to interact with server portion 16 operating on server computer system 10. First client portion 30 may include instructions stored in memory 26 that are executable by one or more processors 28.

A second client computer system 32 is also shown in FIG. 1. Similar to first client computer system 24, second client computer system 32 may include memory 34, a processor 36, and may operate a second client portion 38 of the client-server application. It should be understood that while two client portions are shown in FIG. 1, any number of client portions operating on any number of client computer systems may interact with server portion 16. One or more client portions (e.g., 30, 38) together with server portion 16 may form the client-server application.

In various embodiments, a client-server application formed by a server portion and one or more client portions may be an online game. For example, the client-server application may be a multi-player shooting game where one user may interact with first client portion 30 operating on first client computer system 24 to participate in simulated armed combat with another user interacting with second client portion 38 on second client computer system 32.

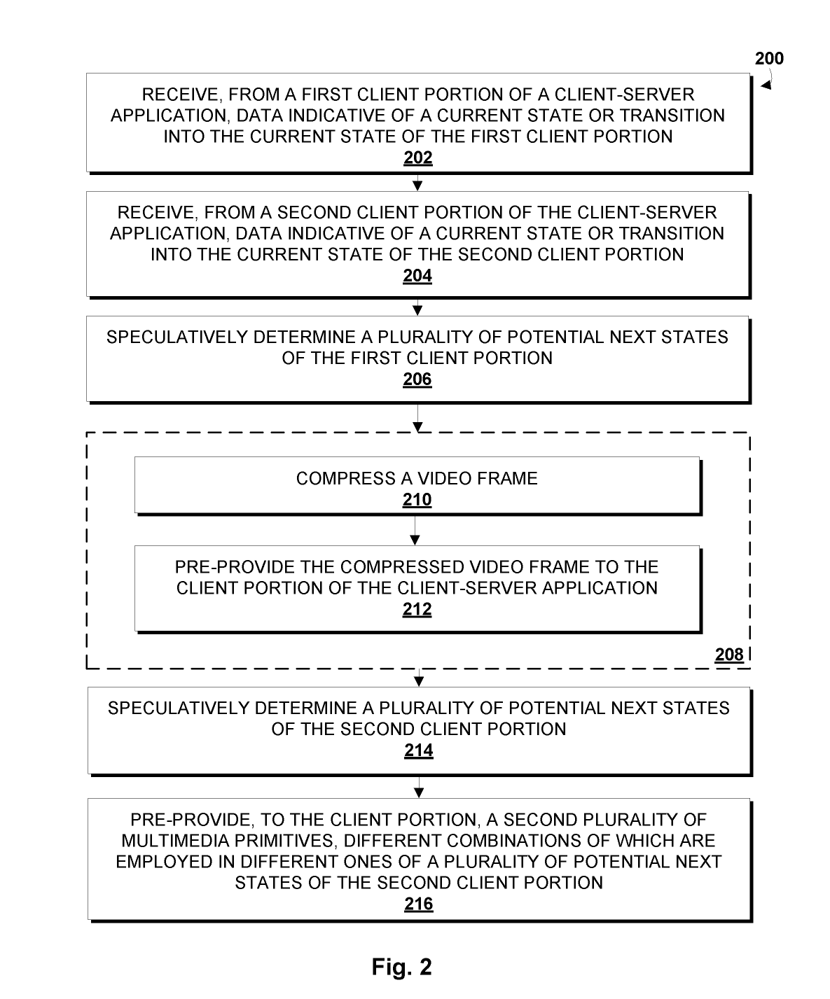

An example method 200 that may be implemented by server portion 16 to interact with client portions such as 30 or 38 is shown in FIG. 2. At block 202, server portion 16 may receive, e.g., from first client portion 30, data indicative of a current state or transition into the current state of first client portion 30. For example, server portion 16 may receive data indicative that a user of first client portion 30 has moved an avatar in an online game into a room.

In some embodiments, at block 204, server portion 16 may additionally receive, e.g., from second client portion 38 of the client-server application, data indicative of a current state or transition into the current state of the second client portion 38.

At block 206, server portion 16 may speculatively determine a plurality of potential next states of first client portion 30 of the client-server application. This speculation may be based on various data, such as user data 18 and/or data received at block 202 or 204.

In some embodiments, the speculation may be based at least in part on measured user data 20 and/or statistical models of user behavior. For example, past actions taken by users having skill levels similar to that of the user interacting with first client portion 30 may be examined to speculate what the user is likely to do next with an avatar after the user moves the avatar into a room. In some embodiments, the speculation may be based at least in part on demographic data of the user interacting with first client portion 30. For example, if the user is a male between twenty and thirty years old, server portion 16 may examine user data 18 to determine what actions other male users between twenty and thirty years old would take or have taken under similar circumstances. Other non-limiting examples of individual or aggregate user demographic information that may be used to speculate potential next states may include income level, location, marital status, nationality, religion, ethnicity, and so forth.

In some embodiments, the speculation may be based at least in part on input control physics. For example, if an avatar controlled by a user is controlled to throw a virtual object, control physics such as virtual wind speed, strength of the avatar (e.g., proportional to time spent playing a game), mass of the virtual object, and other similar data may be used to speculate where the virtual object may land or where/when it may collide with another virtual object. Input control physics may be based on various other types of data, including but not limited to time spent playing a game, a type of game being played, user data 18, user demographic information, and so forth.

At block 208, server portion 16 may pre-provide, e.g., to first client portion 30, a plurality of multimedia primitives, different combinations of which may be employed in different ones of a plurality of potential next states of first client portion 30. For example, server portion 16 may transmit a matrix of multimedia primitives to first client portion 30. This may enable first client portion 30 to reduce transition time to one of the potential next states of first client portion 30. In some embodiments, the multimedia primitives may include visual primitives and/or sound primitives.

For example, server portion 16 may have speculated at block 206 that an avatar controlled by first client portion 30 is likely, after entering a room, to open a door, open a chest or attack a character in the room. Server portion 16 may generate multimedia primitives corresponding to each of these potential next states of first client portion 30 and send those to first client portion 30. When the user interacting with first client portion 30 makes the next move, first client portion 30 may employ one of the multimedia primitives received from server portion 16 to display (and/or provide other output such as sounds), to the user interacting with first client portion 30. Accordingly, the user interacting with first client portion 30 may experience little or no latency because when the user chooses the next action, first client portion 30 already possesses the corresponding multimedia primitive.

As an example, in FIG. 2, pre-providing a plurality of multimedia primitives may include, at block 210, server portion 16 compressing a video frame. The video frame may be one of a plurality of video frames corresponding to potential next states of client portion 30. At block 212, server portion 16 may pre-provide the compressed video frame(s) to first client portion 30 of the client-server application.

Multimedia primitives may include other types of multimedia data besides video frames. In various embodiments, multimedia primitives may include data and/or instructions for outputting sound.

In various embodiments, pre-providing a plurality of multimedia primitives may include pre-providing instructions and/or computer code that may enable a client portion to create output representative of a next state of the client portion. For example, a set of vector graphic instructions may be pre-provided for rendering a vector graphic visual on the client computer system. Unlike bitmap images, which may include a relatively large amount of data and require more bandwidth and/or time to transmit across a network, vector graphic instructions may be less-data intensive (e.g., due to being character-based) and therefore may require less storage and less time to transmit. As another example, pre-providing a plurality of multimedia primitives may include pre-providing metadata for rendering a three-dimensional (“3D”) visual on the client computer system. Similar to vector graphics, 3D graphics may be in non-bitmap form and may include metadata that instructs a processor and/or a separate graphics processor to render a 3D image on a display.

In some embodiments, pre-providing a plurality of multimedia primitives may include pre-providing a plurality of sub-frames and a background frame. The background frame may not change or may change relatively little over a time interval. The sub-frames may include images that change often (e.g., moving images) and may be displayed on top of the background frame. In some cases, a sub-frame may include less data than the background frame. Pre-providing a plurality of sub-frames for a single background frame may reduce an amount of data transmitted between server portion 16 and first client portion 30.

In some embodiments, such as embodiments where the client-server application is a multiplayer online game, server portion 16 may attempt to hide latency experienced between different players. For instance, at block 214, server portion 16 may speculatively determine a second plurality of potential next states, e.g., of second client portion 38. This speculation may be based on similar data as the speculation of block 206, including but not limited to measured user behavior, statistical models of user behavior and/or input control physics.

At block 216, server portion 16 may pre-provide, to first client portion 30, a second plurality of multimedia primitives, different combinations of which are based on different ones of potential next states of second client portion 38, and different combinations of which may be employed in different ones of the plurality of potential next states of first client portion 30. In this manner, first client portion 30 may employ multimedia primitives associated with potential next states of both first client portion 30 and other client portions (e.g., 38) to render output, reducing or eliminating latency experienced by a user. For example, first client portion 30 may select one multimedia primitive from the plurality pre-provided at block 208 and another primitive from the plurality pre-provided at block 216, and combine the two into a composite output.

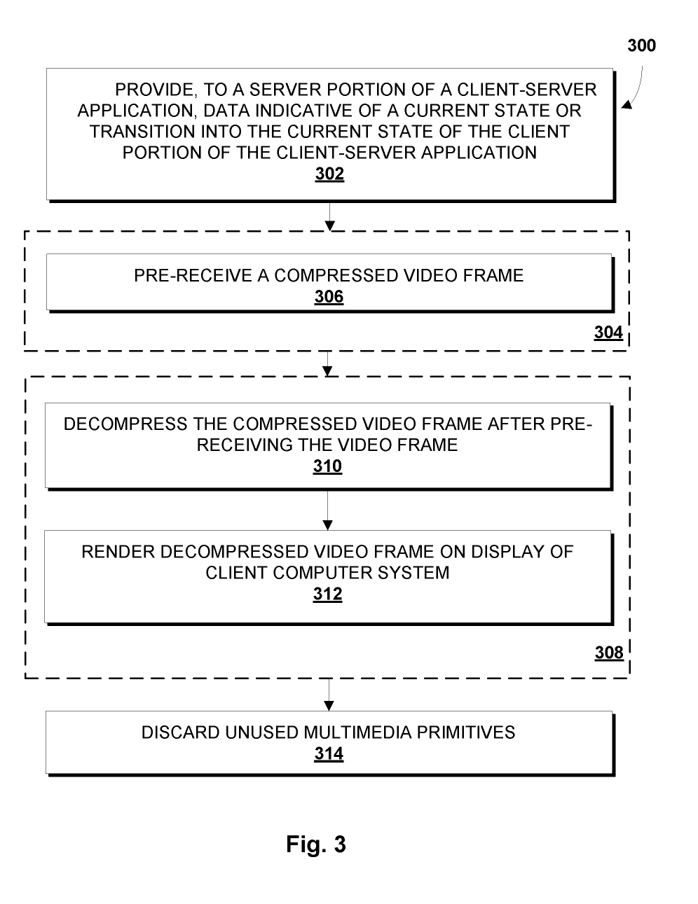

FIG. 3 depicts a method 300 that may be implemented by, e.g., first client portion 30, in accordance with various embodiments, to utilize pre-provided multimedia primitives provided by, e.g., server portion 16. At 302, first client portion 30 may provide, e.g., to server portion 16, data indicative of a current state or transition into the current state of first client portion 30. In some embodiments, this data may be the same data received by server portion 16 at 202. For example, first client portion 30 may provide data indicative that a user of first client portion 30 has moved an avatar in an online computer game into a room.

At 304, first client portion 30 may pre-receive, e.g., from server portion 16, a plurality of multimedia primitives. Different combinations of the received plurality of multimedia primitives may be employed in different ones of a plurality of potential next states of first client portion 30, to enable first client portion 30 to reduce transition time to one of the potential next states.

As was the case with server portion 16, multimedia primitives received by first client portion 30 may include various types of data. In the example of FIG. 3, pre-receiving a plurality of multimedia primitives includes, at block 306, first client portion 30 pre-receiving a compressed video frame, e.g., as one of a matrix of pre-received video frames that may correspond to potential next states of first client portion 30. As noted above, multimedia primitives received by first client portion 30 may additionally or alternatively include sound data, vector graphic instructions, 3D metadata, sound primitives, and so forth.

At block 308, first client computer system 24 and/or first client portion 30 may employ one or more multimedia primitives selected from the pre-received plurality of multimedia primitives, e.g., that correspond to a next state of first client portion 30, to render output. For example, at block 310, first client portion 30 may decompress the video frame pre-received at block 306. At block 312, first client computer system 24 and/or first client portion 30 may render the decompressed video frame immediately, rather than waiting for the video frame to be transmitted from server portion 16. This may reduce or eliminate appearance of latency at first client portion 30.

In various embodiments, first client portion 30 may wait until after the user changes a state of first client portion 30 (e.g., by taking some action) to select and decompress the video frame (block 310). That way first client portion 30 may only use resources decompressing one selected video frame, rather than a plurality of video frames. In various embodiments, at block 314, first client portion 30 may discard unused multimedia primitives such as unused video frames.

In various embodiments, some elements of output at a client portion of a client-server application may be rendered in real time in response to user interactions, and other portions may be rendered using multimedia primitives pre-received from a server portion of the client-server application. For example, many online games allow users to exchange textual messages. These messages may be displayed immediately by a client portion (e.g., via a “heads-up display,” or “HUD”), and representative instructions to display the textual message may be sent later to a server portion.

Similarly, in some online games, an avatar such as a character or a car controlled by a user may be rendered in real time on a client portion controlled by the user. Data for certain other output elements, such as scene geometry, physics data, Z-buffer data, game state data and/or collision information may be provided by a server portion to a client portion via a plurality of speculated multimedia primitives, as described above. The avatar and these pre-received primitives may be combined by a client portion to render output.

For example, data representing a road on which a 3D car is racing may be sent to first client portion 30 as stream of multimedia primitives from which first client portion 30 may select in response to user interaction, as described above. However, the car itself may be rendered in real time on first client portion 30 directly in response to user interaction. The road and the car may be combined by first client portion 30 to render visual and/or audio output to the user. The user interaction may not be provided to server portion 16 until after being rendered by first client portion 30, so that server portion 16 may continue to speculate and pre-provide further multimedia primitives. Thus, server portion 16 may adjust its state data in the background, without the user of first client portion 30 experiencing noticeable latency.

As mentioned previously, in addition to pre-received multimedia primitives that relate to potential next states of first client portion 30, first client portion 30 may pre-receive multimedia primitives relating to potential next states of other client portions of a client-server application, such as second client portion 38. First client portion 30 may render output in real time based on the user's interactions with speculated interactions by users of other client portions. Actual interaction by the user of first client portion 30 may be sent to server portion 16 with latency. Server portion 16 may dynamically adapt future multimedia primitives to be provided to client portions (e.g., 30, 38) to compensate for errors in speculated interactions by other users. Thus, users of client portions may perceive a consistent, low-latency, closer to real-time gaming experience.

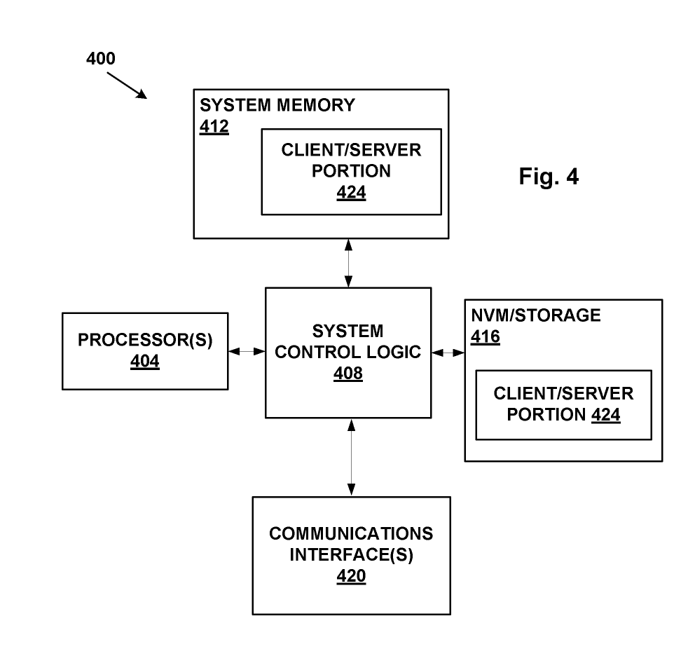

The techniques and apparatus described herein may be implemented into a system using suitable hardware and/or software to configure as desired. FIG. 4 illustrates, for one embodiment, an example system 400 including one or more processor(s) 404, system control logic 408 coupled to at least one of the processor(s) 404, system memory 412 coupled to system control logic 408, non-volatile memory (“NVM”)/storage 416 coupled to system control logic 408, and one or more communications interface(s) 420 coupled to system control logic 408.

System control logic 408 for one embodiment may include any suitable interface controllers to provide for any suitable interface to at least one of the processor(s) 404 and/or to any suitable device or component in communication with system control logic 408.

System control logic 408 for one embodiment may include one or more memory controller(s) to provide an interface to system memory 412. System memory 412 may be used to load and store data and/or instructions, for example, for system 400. System memory 412 for one embodiment may include any suitable volatile memory, such as suitable dynamic random access memory (“DRAM”), for example.

System control logic 408 for one embodiment may include one or more input/output (“I/O”) controller(s) to provide an interface to NVM/storage 416 and communications interface(s) 420.

NVM/storage 416 may be used to store data and/or instructions, for example. NVM/storage 416 may include any suitable non-volatile memory, such as flash memory, for example, and/or may include any suitable non-volatile storage device(s), such as one or more hard disk drive(s) (“HDD(s)”), one or more solid-state drive(s), one or more compact disc (“CD”) drive(s), and/or one or more DVD drive(s) for example.

The NVM/storage 416 may include a storage resource physically part of a device on which the system 400 is installed or it may be accessible by, but not necessarily a part of, the device. For example, the NVM/storage 416 may be accessed over a network via the communications interface(s) 420.

System memory 412 and NVM/storage 416 may include, in particular, temporal and persistent copies of a client and/or server portion 424 of a client-server application, respectively. The client/server portion 424 may include instructions that when executed by at least one of the processor(s) 404 result in the system 400 performing operations to pre-provide and/or pre-receive multimedia primitives, as described above. In some embodiments, the client/server portion 424 may additionally/alternatively be located in the system control logic 408.

Communications interface(s) 420 may provide an interface for system 400 to communicate over one or more network(s) and/or with any other suitable device. Communications interface(s) 420 may include any suitable hardware and/or firmware. Communications interface(s) 420 for one embodiment may include, for example, a wireless network adapter.

For one embodiment, at least one of the processor(s) 404 may be packaged together with logic for one or more controller(s) of system control logic 408. For one embodiment, at least one of the processor(s) 404 may be packaged together with logic for one or more controllers of system control logic 408 to form a System in Package (“SiP”). For one embodiment, at least one of the processor(s) 404 may be integrated on the same die with logic for one or more controller(s) of system control logic 408. For one embodiment, at least one of the processor(s) 404 may be integrated on the same die with logic for one or more controller(s) of system control logic 408 to form a System on Chip (“SoC”).

The system 400 may be a desktop or laptop computer, a mobile telephone, a smart phone, a game console, a set-top box, or any other device adapted to operate a client or server portion of a client-server application. In various embodiments, system 400 may have more or less components, and/or different architectures.

Although specific embodiments have been illustrated and described herein, it is noted that a wide variety of alternate and/or equivalent implementations may be substituted for the specific embodiment shown and described without departing from the scope of the present disclosure. The present disclosure covers all methods, apparatus, and articles of manufacture fairly falling within the scope of the appended claims either literally or under the doctrine of equivalents. This application is intended to cover any adaptations or variations of the embodiment disclosed herein. Therefore, it is manifested and intended that the present disclosure be limited only by the claims and the equivalents thereof.

What is claimed is:

1. A computer-implemented method, comprising:
receiving, by a server portion of a client-server portion application, from a client portion of the client-server application, data indicative of a current state or transition into the current state of the client portion of the client-server application, the client portion and the server portion of the client-server application respectively operating on a client computer system and a server computer system; and
pre-providing, by the server portion, to the client portion, a plurality of multimedia primitives, different combinations of which are employed in different ones of a plurality of potential next states of the client portion, to enable the client portion to reduce transition time to one of the potential next states.

2. The computer-implemented method of claim 1, wherein pre-providing a plurality of multimedia primitives comprises pre-providing a video frame.

3. The computer-implemented method of claim 2, further comprising compressing, by the server portion, the video frame before pre-providing the video frame to the client portion.

4. The computer-implemented method of claim 1, wherein pre-providing a plurality of multimedia primitives includes pre-providing a set of vector graphic instructions for rendering a vector graphic visual on the client computer system.

5. The computer-implemented method of claim 1, wherein pre-providing a plurality of multimedia primitives includes pre-providing metadata for rendering a three dimensional visual on the client computer system.

6. The computer-implemented method of claim 1, further comprising speculatively determining, by the server portion, the plurality of potential next states of the client portion based at least in part on measured user behavior.

7. The computer-implemented method of claim 1, further comprising speculatively determining, by the server portion, the plurality of potential next states of the client portion based at least in part on statistical models of user behavior.

8. The computer-implemented method of claim 1, further comprising speculatively determining, by the server portion, the plurality of potential next states of the client portion based at least in part on input control physics.

9. The computer-implemented method of claim 1, wherein pre-providing a plurality of multimedia primitives comprises pre-providing a plurality of sub-frames and a background frame.

10. The computer-implemented method of claim 1, wherein the multimedia primitives further comprise instructions executable by the client portion to transition the client portion to one of the potential next states.

11. The computer-implemented method of claim 1, wherein the client portion is a first client portion, the client computer system is a first client computer system, and the method further comprises:
receiving, by the server portion, from a second client portion of the client-server application, data indicative of a current state or transition into the current state of the second client portion, the second client portion operating on a second client computer system; and
pre-providing, by the server portion, to the first client portion, a second plurality of multimedia primitives, different combinations of which are employed in different ones of a plurality of potential next states of the second client portion.

12. The computer-implemented method of claim 11, further comprising speculatively determining, by the server portion, the second plurality of potential next states of the second client portion based on one or more of measured user behavior, statistical models of user behavior or input control physics.

13. The computer-implemented method of claim 1, wherein the client-server application is an online computer game.

14. A computer-implemented method, comprising:
providing, by a client portion of a client-server portion application, to a server portion of the client-server application, data indicative of a current state or transition into the current state of the client portion of the client-server application, the client portion and the server portion of the client-server application respectively operating on a client computer system and a server computer system; and
pre-receiving, by the client portion, from the server portion, a plurality of multimedia primitives, different combinations of which are employed in different ones of a plurality of potential next states of the client portion of the client-server application, to enable the client portion of the client-server application to reduce transition time to one of the potential next states.

15. The computer-implemented method of claim 14, wherein pre-receiving a plurality of multimedia primitives comprises pre-receiving a video frame.

16. The computer-implemented method of claim 15, further comprising decompressing, by the client computer system, the video frame after pre-receiving the video frame.

17. The computer-implemented method of claim 14, wherein pre-receiving a plurality of multimedia primitives includes pre-receiving a set of vector graphic instructions for rendering a vector graphic visual on the client computer system.

18. The computer-implemented method of claim 14, wherein pre-receiving a plurality of multimedia primitives includes pre-receiving metadata for rendering a three dimensional visual on the client computer system.

19. The computer-implemented method of claim 14, wherein pre-receiving a plurality of multimedia primitives comprises pre-receiving a plurality of sub-frames and a background frame.

20. The computer-implemented method of claim 14, wherein the multimedia primitives further comprise sound primitives.

21. The computer-implemented method of claim 14, further comprising pre-receiving, by the client portion, from the server portion, a second plurality of multimedia primitives, different combinations of which are based on different ones of a plurality of potential next states of a second client portion, and different combinations of which are employed in different ones of a plurality of potential next states of the first client portion.

22. A non-transitory computer-readable medium having computer-readable code embodied therein, the computer-readable code comprising instructions configured to enable a server computer system, in response to execution of the instructions, to perform a number of operations, including:
receiving, from a client portion of a client-server application, data indicative of a current state or transition into the current state of the client portion of the client-server application, the client portion operating on a client computer system;
speculatively determining a plurality of potential next states of the client portion; and
pre-providing, to the client portion, a plurality of multimedia primitives, different combinations of which are employed in different ones of the plurality of potential next states of the client portion, to enable the client portion to reduce transition time to one of the potential next states.

23. The non-transitory computer-readable medium of claim 22, wherein the client portion is a first client portion, the client computer system is a first client computer system, and the operations further include:
receiving, from a second client portion of the client-server application, data indicative of a current state or transition into the current state of the second client portion, the second client portion operating on a second client computer system;
speculatively determining a plurality of potential next states of the second client portion; and
pre-providing, to the first client portion, a second plurality of multimedia primitives, different combinations of which are based on different ones of the potential next states of the second client portion, and different combinations of which are employed in different ones of the plurality of potential next states of the first client portion.

24. A non-transitory computer-readable medium having computer-readable code embodied therein, the computer-readable code comprising instructions configured to enable a client computer system, in response to execution of the instructions, to perform a number of operations, including:
providing, to a server portion of a client-server application, data indicative of a current state or transition into the current state of a client portion of the client-server application, the client portion of the client-server application operating on the client computer system and the server portion of the client-server application operating on a server computer system; and
pre-receiving, from the server portion, a plurality of multimedia primitives, different combinations of which are employed in different ones of a plurality of potential next states of the client portion, to enable the client portion to reduce transition time to one of the potential next states.
